(19) United States
(12) Patent Application Publication
(10) Pub. No.: US 2022/0324094 A1
(43) Pub. Date: Oct. 13, 2022

(54) Sanitary Touch Stick Apparatus

(71) Applicant: Pamela Brown, Fort Benning, GA (US)

(72) Inventor: Pamela Brown, Fort Benning, GA (US)

(21) Appl. No.: 17/224,569

(22) Filed: Apr. 7, 2021

(51) Int. Cl. B25J 1/04; B25J 19/00

(52) U.S. Cl. CPC B25J 1/04; B25J 19/0058

(57) ABSTRACT

A sanitary touch stick apparatus for sanitary pressing of buttons and touch screens includes a base having a base stick end, a base cap end, and a base sidewall. A sponge is coupled within the base. The sponge has a stick aperture extending from a sponge stick end through a sponge cap end. The sponge is saturated with a disinfectant solution. A cap is coupled to the base. The cap is selectively engageable with the base cap end. A handle is coupled to the base. The handle has an open handle engagement end selectively engageable with the base stick end and a sealed handle outer end. A touch stick is coupled to the handle. The touch stick protrudes from the handle engagement end and is selectively engageable within the stick aperture of the sponge.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to touch devices and more particularly pertains to a new touch device for sanitary pressing of buttons and touch screens. The present device includes a base open on both ends and a cylindrical sponge disposed within the base. One end receives sanitizer to saturate the sponge and an cap while the other end receives a touch stick and handle.

### (2) Description of Related Art including information disclosed under 37 CFR 1.97 and 1.98

The prior art relates to touch devices. Known devices often lack sanitary components. Those that do typically rely on battery-powered ultraviolet lights. Known devices with sanitary sponges include a sponge within a one-sided cap that is prone to leakage when filled.

### BRIEF SUMMARY OF THE INVENTION

An embodiment of the disclosure meets the needs presented above by generally comprising a base having a base stick end, a base cap end, and a base sidewall. A sponge is coupled within the base. The sponge has a stick aperture extending from a sponge stick end through a sponge cap end. The sponge is configured to be saturated with a disinfectant solution. A cap is coupled to the base. The cap is selectively engageable with the base cap end. A handle is coupled to the base. The handle has an open handle engagement end selectively engageable with the base stick end and a sealed handle outer end. A touch stick is coupled to the handle. The touch stick protrudes from the handle engagement end and is selectively engageable within the stick aperture of the sponge.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric view of a sanitary touch stick apparatus according to an embodiment of the disclosure.

FIG. 2 is an isometric exploded view of an embodiment of the disclosure.

FIG. 3 is an isometric exploded view of an embodiment of the disclosure.

FIG. 4 is a cross-sectional view of an embodiment of the disclosure along the line 4-4 of FIG. 1.

FIG. 5 is a cross-sectional view of an embodiment of the disclosure along the line 5-5 of FIG. 2.

### DETAILED DESCRIPTION OF THE INVENTION

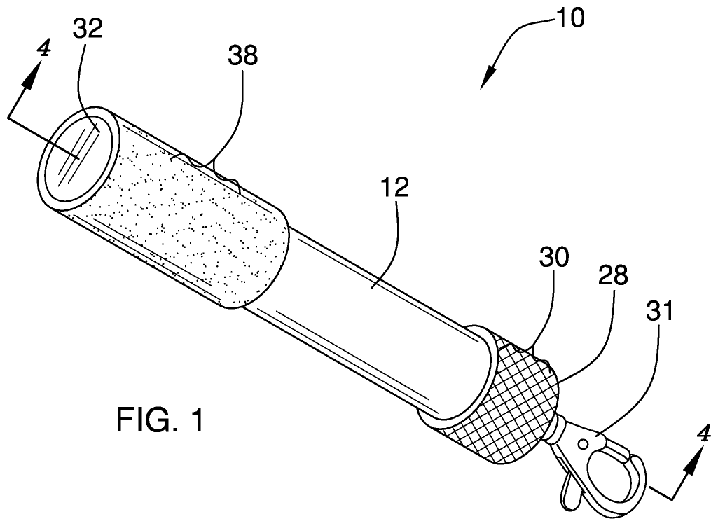

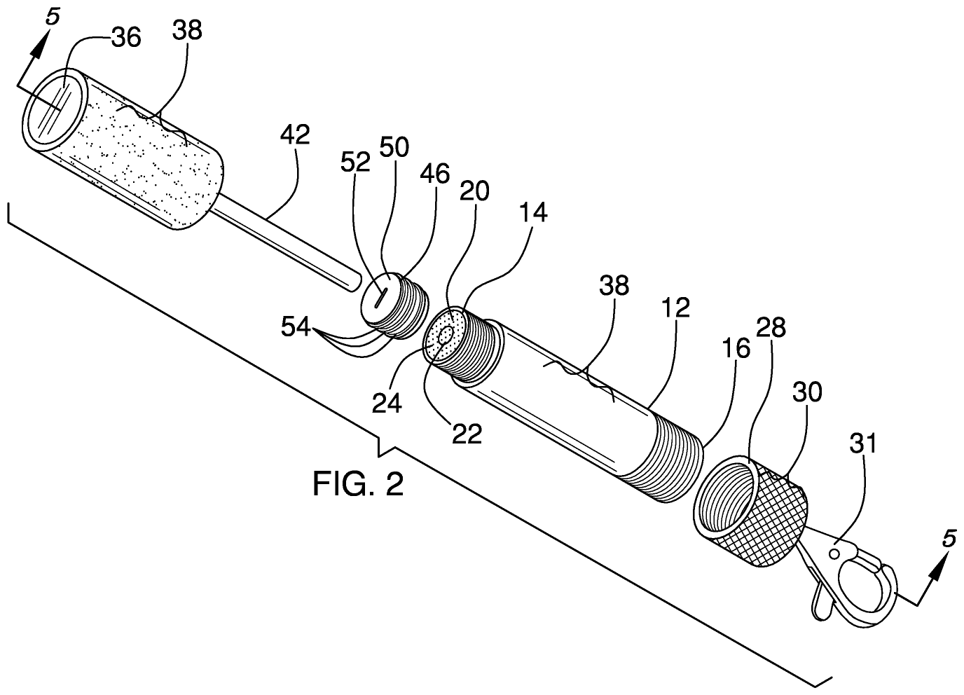

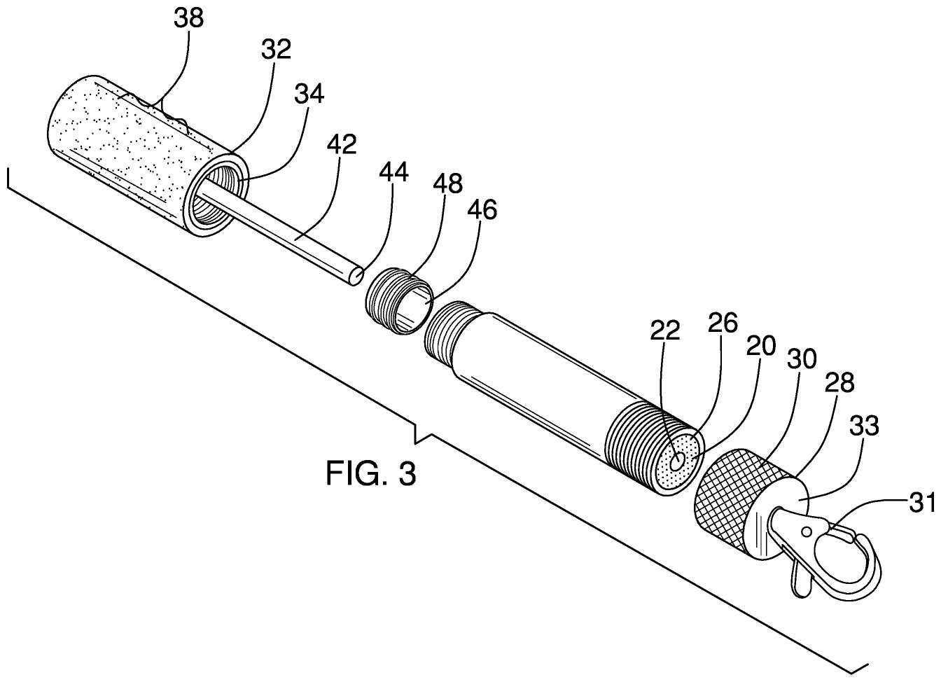

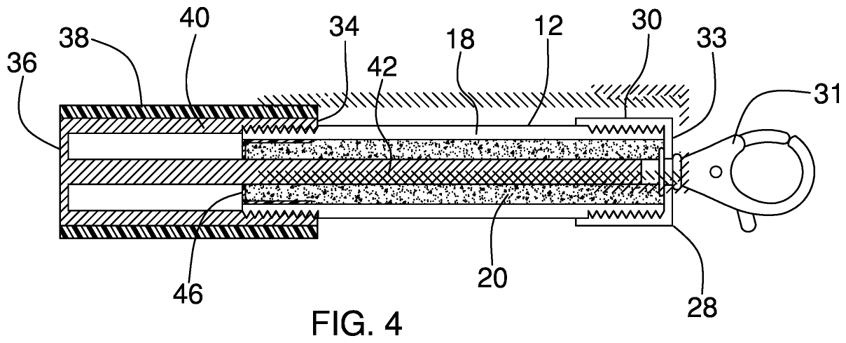

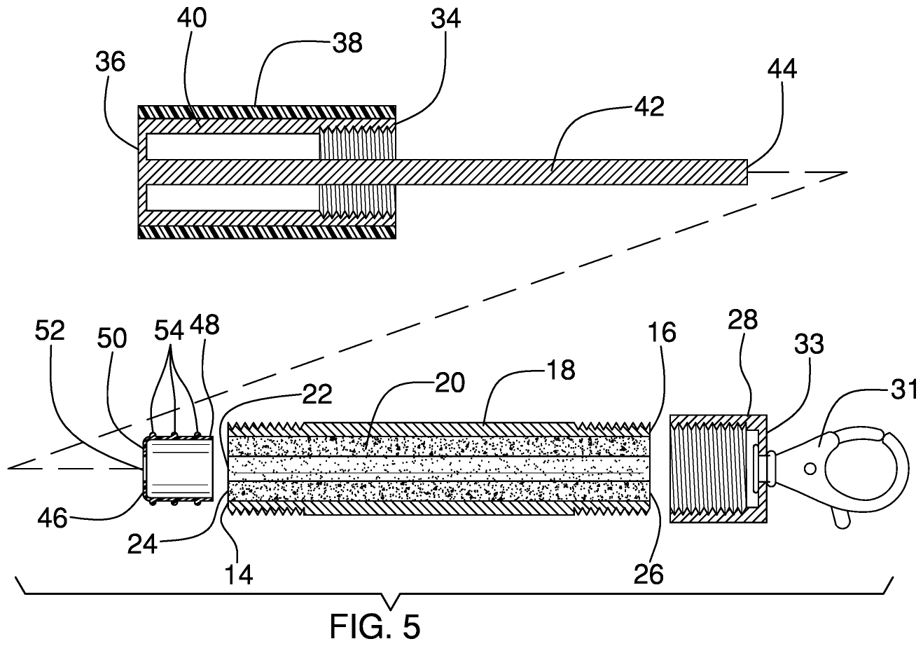

With reference now to the drawings, and in particular to FIGS. 1 through 5 thereof, a new touch device embodying the principles and concepts of an embodiment of the disclosure and generally designated by the reference numeral 10 will be described.

As best illustrated in FIGS. 1 through 5, the sanitary touch stick apparatus 10 generally comprises a base 12 having a base stick end 14, a base cap end 16, and a base sidewall 18. The base 12 may be cylindrical. A sponge 20 may be coupled within the base 12. The sponge 20 is cylindrical and has a stick aperture 22 extending from a sponge stick end 24 through a sponge cap end 26. The sponge 20 is configured to be saturated with a disinfectant solution.

A cap 28 is coupled to the base 12. The cap 28 is selectively engageable with the base cap end 16. The cap 28 may be threadably engageable with the base sidewall 18 adjacent the base cap end 16 of the base. The cap 28 may have a knurled cap sidewall 30 for improved grip. A clasp 31 may be rotatably coupled to a cap end 33 of the cap. The clasp 32 is configured to selectively engage a keychain, bag strap, or the like.

A handle 32 is coupled to the base 12. The handle 32 has an open handle engagement end 34 selectively engageable with the base stick end 14 and a sealed handle outer end 36. The handle 32 may be threadably engageable with the base sidewall 18 adjacent the base stick end 14. A handle cover 38 may be coupled to the handle 32. The handle cover 38 is coupled around a handle wall 40 and may be rubberized to improve user grip.

A touch stick 42 is coupled to the handle 32. The touch stick 42 protrudes from the handle engagement end 34 and is selectively engageable within the stick aperture 22 of the sponge. The touch stick 42 may be coupled within the handle outer end 36. The touch stick 42 is rigid enough to press buttons and may have a conductive stick distal end 44 to serve as a stylus on touchscreens.

A gasket 46 may be coupled to the base 12. The gasket 46 is selectively engageable within the base stick end 14. The gasket 46 has a gasket wall 48 coupled between the sponge 20 and the base sidewall 18 and a gasket face 50. The gasket 46 has a stick slot 52 extending through the gasket face 50. The gasket wall 48 may have a plurality of seal ridges 54 to prevent leakage of the disinfectant solution.

In use, the cap 28 is disengaged to pour disinfectant solution onto the sponge 20. The cap 28 is then reengaged with the base 12. The handle 32 is disengaged from the base 12 as desired to use the touch stick 42 for non-contact sanitary depression of buttons and as a stylus. As the touch stick 42 is reinserted into the stick aperture 22 it is sanitized by the sponge 20.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A sanitary touch stick apparatus comprising:
a base having a base stick end, a base cap end, and a base sidewall;
a sponge coupled within the base, the sponge having a stick aperture extending from a sponge stick end through a sponge cap end, the sponge being configured to be saturated with a disinfectant solution;
a cap coupled to the base, the cap being selectively engageable with the base cap end;
a handle coupled to the base, the handle having an open handle engagement end selectively engageable with the base stick end and a sealed handle outer end; and
a touch stick coupled to the handle, the touch stick protruding from the handle engagement end and being selectively engageable within the stick aperture of the sponge.

2. The sanitary touch stick apparatus of claim 1 further comprising a clasp coupled to the cap, the clasp being configured to selectively engage a keychain, bag strap, or the like.

3. The sanitary touch stick apparatus of claim 1 further comprising the clasp being rotatably coupled to the cap.

3. The sanitary touch stick apparatus of claim 1 further comprising the cap being threadably engageable with the base sidewall adjacent the base cap end of the base.

4. The sanitary touch stick apparatus of claim 1 further comprising the cap being knurled.

5. The sanitary touch stick apparatus of claim 1 further comprising each of the base and the sponge being cylindrical.

6. The sanitary touch stick apparatus of claim 1 further comprising a gasket coupled to the base, the gasket being selectively engageable within the base stick end and having a stick slot to receive the touch stick.

7. The sanitary touch stick apparatus of claim 6 further comprising the gasket having a gasket wall coupled between the sponge and the base sidewall and a gasket face, the stick slot extending through the gasket face.

8. The sanitary touch stick apparatus of claim 7 further comprising the gasket wall having a plurality of seal ridges.

9. The sanitary touch stick apparatus of claim 1 further comprising a handle cover coupled to the handle, the handle cover being coupled around a handle wall.

10. A sanitary touch stick apparatus comprising:
a base having a base stick end, a base cap end, and a base sidewall, the base being cylindrical;
a sponge coupled within the base, the sponge being cylindrical and having a stick aperture extending from a sponge stick end through a sponge cap end, the sponge being configured to be saturated with a disinfectant solution;
a cap coupled to the base, the cap being selectively engageable with the base cap end, the cap being threadably engageable with the base sidewall adjacent the base cap end of the base, the cap being knurled;
a clasp coupled to the cap, the clasp being configured to selectively engage a keychain, bag strap, or the like;
a handle coupled to the base, the handle having an open handle engagement end selectively engageable with the base stick end and a sealed handle outer end;
a handle cover coupled to the handle, the handle cover being coupled around a handle wall;
a touch stick coupled to the handle, the touch stick protruding from the handle engagement end and being selectively engageable within the stick aperture of the sponge; and
a gasket coupled to the base, the gasket being selectively engageable within the base stick end, the gasket having a gasket wall coupled between the sponge and the base sidewall and a gasket face, the gasket having a stick slot extending through the gasket face, the gasket wall having a plurality of seal ridges.
